(19) United States
(12) Patent Application Publication
(10) Pub. No.: US 2022/0327387 A1
(43) Pub. Date: Oct. 13, 2022

(54) MORE ROBUST TRAINING FOR ARTIFICIAL NEURAL NETWORKS

(71) Applicant: Robert Bosch GmbH, Stuttgart (DE)

(72) Inventor: Nicolai Waniek, Dornstadt (DE)

(21) Appl. No.: 17/657,041

(22) Filed: Mar. 29, 2022

(30) Foreign Application Priority Data
Apr. 13, 2021 (DE) 10 2021 109 168.3

(51) Int. Cl. G06N 3/08; G06F 7/58

(52) U.S. Cl. CPC G06N 3/082; G06F 7/582

(57) ABSTRACT

A method for training an artificial neural network, ANN, which comprises a multiplicity of processing units. Parameters that characterize the behavior of the ANN are optimized according to a cost function. Depending on outputs determined from learning input quantity values and on learning output quantity values, an output of at least one selected processing unit is deactivated. Selection of the selected processing unit is achieved with the aid of a sequence of quasi-random numbers.

### CROSS REFERENCE

The present application claims the benefit under 35 U.S.C. § 119 of German Patent Application No. DE 10 2021 109 168.3 filed on Apr. 13, 2021, which is expressly incorporated herein by reference in its entirety.

### FIELD

The present invention relates to the training of artificial neural networks, for example for use as a classifier, and to a computer program, a machine-readable storage medium, and a training device.

### BACKGROUND INFORMATION

Artificial neural networks, ANNs, are configured to map input quantity values onto output quantity values in accordance with a behavioral rule that is specified by a parameter set. The behavioral rule is not defined in the form of verbal rules, but by the numerical values of the parameters in the parameter set. During training of the ANN, the parameters are optimized such that the ANN maps learning input quantity values onto associated learning output quantity values as well as possible. The ANN is then expected to generalize appropriately the knowledge gained during training. Thus, input quantity values are still to be mapped onto output quantity values that are usable for the respective application even if they relate to unknown situations that did not arise in training.

During such training of the ANN, there is fundamentally a risk of overfitting. This means that the ANN learns to correctly map the learning input quantity values onto the learning output quantity values with a high level of accuracy and “verbatim”, at the expense of a worsening of generalization to new situations.

German Patent Application No. DE 10 2019 210 167 A1 describes a method for training an artificial neural network in which at least some of the outputs from processing units are multiplied by random numbers that are picked at random from a Laplace distribution.

“Improving neural networks by preventing co-adaptation of feature detectors”, Geoffrey E. Hinton, Nitish Srivastava, Alex Krizhevsky, Ilya Sutskever and Ruslan R. Salakhutdinov, arXiv preprint arXiv:1207.0580v1 (2012) describes a method for training a feedforward neural network by randomly omitting half of the feature detectors during each training case. This method is generally known as dropout.

Further methods for training neural networks using randomly deactivated feature detectors are described in “DropBlock: A regularization method for convolutional networks” by Ghiasi et al. 2018 (https://arxiv.org/abs/1810.12890), and “Pushing the bounds of Dropout” by Melis et al. 2018 (https://arxiv.org/pdf/1805.09208.pdf).

Typically, dropout is studied from a probabilistic perspective, for example as described in “Dropout as a Bayesian Approximation: Representing Model Uncertainty in Deep Learning” by Gal et al. 2015 (https://arxiv.org/pdf/1506.02142v1).

The relevant point in all variants of dropout is that neurons are selected (pseudo-)randomly, or pseudo-randomly with a random number generator, for example by drawing a random number p and deactivating the feature detectors if p is above (or below) a particular threshold value. Although later variants of dropout have introduced different techniques for selecting these feature detectors, they all operate by the same fundamental mode.

### SUMMARY

A method having the features in accordance with the present invention, and the devices having the features in accordance with the present invention, may have the advantage that an evenly distributed selection of deactivated feature detectors, which can improve and avoid the need for training times, remains at local minimum values.

Pseudo-random number generators tend to generate numbers that are not evenly distributed in the output space. To be more precise, generated pseudo-random numbers tend to group numbers in specific regions of the output domain while leaving other regions empty. In the case of dropout, this can result in specific groups of feature detectors not being deactivated during training. By contrast, quasi-random numbers—that is to say numbers generated with a so-called low-discrepancy sequence-cover the target domain evenly.

Further, the use of a pseudo-random number generator takes considerable processing power, and includes a plurality of operations per neuron. Since modern deep networks may comprise upward of millions of neurons, the effective reduction of this processing load may result in a shorter training time. By contrast, the calculation of low-discrepancy sequences is more efficient, since it requires significantly fewer calculations for each calculation of an individual number than a pseudo-random number generator. This shortens the training times of neural networks.

Moreover, low-discrepancy sequences can be computed on a regular CPU without the need for additional hardware. By contrast, real random number generators require dedicated hardware.

Developments and example embodiments of the present invention are disclosed herein.

Within the scope of the present invention, a method is provided for training an artificial neural network, ANN. The ANN comprises a multiplicity of processing units, which may correspond for example to neurons of the ANN. The ANN serves to map input quantity values onto output quantity values that are meaningful in the context of the respective application.

Here, in each case the term “values” is not to be understood restrictively as regards dimensionality. Thus, if the ANN is configured to process image data, an image of this kind may take the form for example of a tensor comprising three color planes, each with a two-dimensional array of intensity values of individual pixels. The ANN may receive this image as a whole as the input quantity value, and allocate to it for example a vector of classifications as the output quantity value. This vector may for example, for each class of the classification, specify the probability or confidence level of an object of the corresponding class being present in the image. Here, the image may have a size of for example at least 8×8, 16×16, 32×32, 64×64, 128×128, 256×256 or 512×512 pixels, and may be captured with the aid of an imaging sensor, for example a video, ultrasound, radar or lidar sensor or a thermal imaging camera. The ANN may in particular be a deep neural network—that is may comprise at least two hidden layers. The number of processing units is preferably large, for example greater than 1,000, preferably greater than 10,000.

The ANN may in particular be embedded in a control system which, depending on the determined output quantity values, provides a control signal for appropriate control of a vehicle and/or a robot and/or a production machine and/or a tool and/or a monitoring camera and/or a medical imaging system.

During training, parameters which characterize the behavior of the ANN are optimized. The objective of this optimization is for the ANN to map learning input quantity values onto associated learning output quantity values as well as possible in accordance with a cost function.

In a first aspect, the present invention relates to a method for training an artificial neural network, ANN, which comprises a multiplicity of processing units (also known as “neurons” or “feature detectors”). In accordance with an example embodiment of the present invention, parameters that characterize the behavior of the ANN are optimized with the objective that the ANN will map learning input quantity values onto associated learning output quantity values as well as possible in accordance with a cost function (that is to say that optimization of the cost function should result in the desired achievement of the learning objective), the output of at least one selected processing unit being deactivated, and selection of the selected processing unit being achieved with the aid of a sequence of quasi-random numbers.

The term “deactivated” here may mean for example that the output of the processing unit is set to a constant value, such as the value zero, regardless of the values applying at an input of the processing unit.

It was seen that, surprisingly, this suppresses the tendency to overfitting even better than the above-mentioned methods of the related art. This means that an ANN trained in this way is better able to determine output quantity values that achieve the objective for the respective application if it is supplied with input quantity values relating to hitherto unknown situations.

An application in which ANNs have to prove the worth of their ability to generalize to a particular degree is the at least partly automated driving of vehicles for example on the public roads. Analogously to the training of human drivers, who usually spend less than 50 hours at the wheel and cover less than 1,000 km before their test, ANNs also have to cope with training covering a limited number of situations. The limiting factor here is that “labeling” learning input quantity values, such as camera images from the environment around the vehicle, with learning output quantity values, such as a classification of the objects visible in the images, in many cases requires human effort and is correspondingly expensive. Similarly, it is indispensable to safety that a car of extravagant design that is commercialized later on is still recognized as a car, and that a pedestrian is not classified as a surface that may readily be driven over just because they are wearing clothing of a flamboyant pattern.

Thus, in these and other applications relevant to safety, better suppression of overfitting has the result that more trust can be put in the output quantity values output by the ANN, and that a smaller quantity of learning data is required to achieve the same level of safety.

Moreover, concomitant with better suppression of overfitting is the fact that the robustness of training is improved. A technically important criterion for robustness is the extent to which the quality of the training result depends on the initial state from which training started. Thus, the parameters that characterize the behavior of the ANN are typically initialized randomly and then successively optimized. In some applications, such as the transfer of images between domains respectively representing different styles of image with the aid of generative adversarial networks, it may be difficult to predict whether training that starts with random initialization will deliver an ultimately usable result. It is possible that in this case multiple runs will be necessary before the training result is usable for the respective application.

In this situation, better suppression of overfitting saves on processing time for unsuccessful runs, or conversely, with a specified processing time, results in a better-functioning ANN.

The cause of better suppression of overfitting is that the variability in the learning input quantity values, on which the ability of the ANN to generalize depends, is amplified by the quasi-random influence on the processing units. This has the result that influencing the processing units generates fewer discrepancies from the ground truth used for the training, which is embodied in labeling the learning input quantity values with the learning output quantity values.

In an advantageous specific embodiment of the present invention, it may be provided for the sequence of quasi-random numbers to be initialized using a random value. Starting from this random value, the sequence of quasi-random numbers is strictly deterministic.

For example, it is possible that there will be generated from the sequence of quasi-random numbers a number of indices of processing units that are to be deactivated. Because sequences of quasi-random numbers often give real (and non-integer) numbers, for example in the case of the interval [0,1], it is necessary to map onto discrete indices, for example by multiplication and truncation or rounding.

This can be done for example in that, for a sequence d of real-value quasi-random numbers in the interval [0,1] for a neural network layer having N many neurons, the sequence of quasi-random numbers is transformed into an index having the function h(x)=floor(x*N), where floor rounds a value to the nearest integer.

It goes without saying that, instead of the floor function, other methods may also be used that map a floating-point value onto an integer, such as the so-called “ceiling” function, which rounds up.

For example, it is possible that the relevant initialization of the sequence of quasi-random numbers is changed after each training pass has been carried out, for example after each sequence of a forward pass and subsequent backward pass, in the known backpropagation algorithm.

In pseudocode, this training may look like this:
Until training is complete:
   Choose a value i_offset at random
   Calculate deterministically a sequence s of quasi-random numbers with C many elements
   For every j=1 . . . C:
      Deactivate the neuron with index i_offset+h(s[j]) % N
   Perform a forward pass
   Perform a backward pass.

Here, “% N” stands for a modulo operation, which has the effect that indices have no remainder. Here, the function h(x) is defined as described above—that is, it classifies a value x within the range of possible indices.

In a further development of the present invention, it may be provided for the change in the initialization to be performed by a specifiable increment. This has the advantage that in particular fewer random numbers, or no random numbers at all, have to be generated for the initialization, which further enhances processing efficiency.

In pseudocode, the method may look like this:
Choose a value i_offset at random
Until training is complete:
   Calculate deterministically a sequence s of quasi-random
   numbers with C many elements
   For every j=1 . . . C:
      Deactivate the neuron with index i_offset+h(s[j]) % N
   Perform a forward pass
   Perform a backward pass
   Increment i_offset.

In the specific embodiments of the present invention described, it is possible for generation of the sequence of quasi-random numbers to be moved outside the training loop, since the sequence does not change between iterations. That means that they could be moved in front of the line “Until training is complete” in the pseudocode.

Advantageously, it may be provided for a specifiable proportion of the processing units (2) of the ANN (1) to be selected and deactivated—that is to say that in the described exemplary embodiments, the number C of neurons to be deactivated may be determined from this. This has the effect that, in contrast to the conventional dropout method, the number of neurons to be deactivated may be set precisely.

Examples of the sequence of quasi-random numbers are in particular the following sequences:
Halton sequence
Hammersley sequence
Niederreiter sequence
Kronecker sequence
Sobol sequence
Van der Corput sequence.

In a particularly advantageous specific embodiment of the present invention, the ANN is configured as a classifier, in particular of image data and/or audio data. In particular in the context of image data, a classification may also comprise a semantic segmentation (as a pixel-level classification) or a detection (as a classification of whether an object is present or not).

Further measures that improve the present invention are presented in more detail below with reference to figures, in conjunction with the description of the preferred exemplary embodiments of the present invention.

### BRIEF DESCRIPTION OF THE DRAWINGS

FIG. 1 shows an exemplary ANN.

FIG. 2 shows an exemplary device for training the ANN, in accordance with an example embodiment of the present invention.

FIG. 3 shows an exemplary embodiment of a method for training the ANN, in accordance with the present invention.

### DETAILED DESCRIPTION OF EXAMPLE EMBODIMENTS

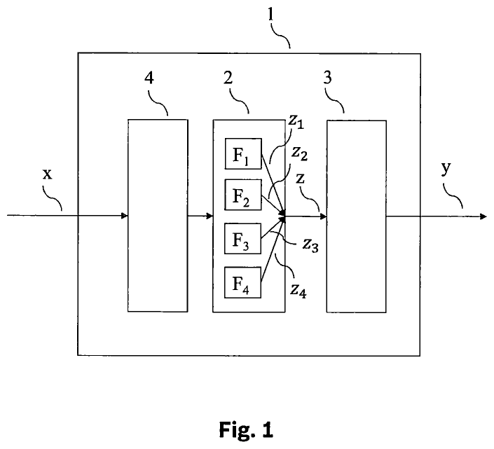

FIG. 1 shows an ANN (1), which comprises layers (2, 3, 4), and is configured to determine from an input quantity value (x) an associated output (y). The input quantity value (x) may be in the form for example of image data, and the output (y) may be for example a semantic segmentation of these image data.

In this context, a selected layer (2) comprises a plurality of neurons (F₁,F₂,F₃,F₄), of which the output values (z₁,z₂,z₃,z₄) are forwarded as a typically multidimensional intermediate quantity (z) to a succeeding layer (3).

The neurons may conventionally be arranged in multidimensional form, for example as a two-dimensional tensor of size M×N. It is possible to index the neurons in one layer by a one-dimensional count of the neurons.

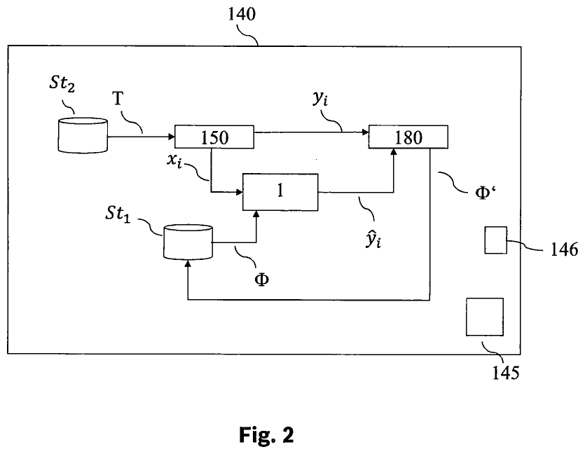

FIG. 2 shows a training device (140) for training the ANN (1). The parameters (Φ) of the ANN (1) are stored in a first memory (St₁). A second memory (St₂) provides training data (T). The training data (T) comprise pairs of learning input quantity values (xᵢ) and respectively associated learning output quantity values (yᵢ). During training, a unit (150) supplies input quantities (xᵢ) to the ANN (1), which determines an associated output (ŷᵢ) from these. This output (ŷᵢ) and the learning output quantity value (yᵢ) are supplied to a comparator (180), which determines a value of a cost function from these—for example, for a mini-batch of such pairs of outputs (ŷᵢ) and the learning output quantity values (yᵢ). With the aid of a suitable optimization algorithm, such as stochastic gradient descent, in so doing new values (Φ′) are determined for the parameters (Φ) of the ANN (1), which are supplied to the first memory (St₁), where they update the existing values.

The training device (140) comprises for example a computer (145) which performs the training method, and a memory (146) in which there is stored a computer program which comprises instructions for performing the training method when it is run by the computer (145).

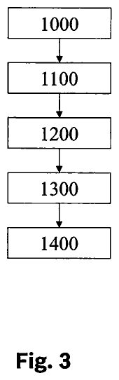

FIG. 3 shows a specific embodiment of a method that is performed by the training device (140).

First (1000), a sequence of quasi-random numbers, for example a Hammersley sequence, is initialized using an initial value, and is generated to a specifiable length. This specifiable length is preferably greater than the number of neurons of the ANN (1) that are to be deactivated.

Then, with the aid of a floor operator, this sequence (1100) is mapped onto integer values in order to obtain a sequence of indices. These indices may either be exclusively neurons (F₁,F₂,F₃,F₄) of the selected layer (2) (with the result that the illustrated method may be repeated layer by layer for the purpose of deactivating neurons), or preferably address all the neurons of the ANN (1).

Thereafter (1200), these neurons are deactivated—that is, the associated output values (z₁,z₂,z₃,z₄) are preferably set to a value of zero.

Then (1300), a forward pass is performed—that is to say that, for learning input quantity values (xᵢ) and respectively associated learning output quantity values (yᵢ), with the aid of the ANN (1) and with neurons deactivated as described, associated output quantities (9) are determined, and the cost function is determined from these.

Thereafter (1400), a backward pass is performed—that is to say that, for example with the aid of gradient formation of the cost function and backpropagation, the weights of the non-deactivated neurons are adapted.

This procedure can be iterated until the training method is complete.

What is claimed is:

1. A method for training an artificial neural network (ANN), which includes a multiplicity of processing units, the method comprising:
optimizing parameters that characterize a behavior of the ANN a according to a cost function; and
deactivating, depending on outputs determined from learning input quantity values and on learning output quantity values, an output of at least one selected processing unit, and selection of the selected processing unit being achieved using a sequence of quasi-random numbers.

2. The method as recited in claim 1, wherein the sequence of quasi-random numbers is initialized using a random value.

3. The method as recited in claim 2, wherein the initialization of the sequence of random numbers is changed after each training pass has been carried out.

4. The method as recited in claim 3, wherein the change in the initialization is performed by a specifiable increment.

5. The method as recited in claim 1, wherein a specifiable proportion of the processing units of the ANN is selected and deactivated.

6. The method as recited in claim 1, wherein the sequence of quasi-random numbers is one of the following sequences:
Halton sequence,
Hammersley sequence,
Niederreiter sequence,
Kronecker sequence,
Sobol sequence,
Van der Corput sequence.

7. The method as recited in claim 1, wherein the ANN is configured as a classifier.

8. The method as recited in claim 7, wherein the ANN is configured as a classifier of image data and/or audio data.

9. A non-transitory machine-readable storage medium on which is stored a computer program for training an artificial neural network (ANN), which includes a multiplicity of processing units, the computer program, when executed by a computer, causing the computer to perform the following steps:
optimizing parameters that characterize a behavior of the ANN a according to a cost function; and
deactivating, depending on outputs determined from learning input quantity values and on learning output quantity values, an output of at least one selected processing unit, and selection of the selected processing unit being achieved using a sequence of quasi-random numbers.

10. A training device configure to train an artificial neural network (ANN), which includes a multiplicity of processing units, the training device configured to:
optimize parameters that characterize a behavior of the ANN a according to a cost function; and
deactivate, depending on outputs determined from learning input quantity values and on learning output quantity values, an output of at least one selected processing unit, and selection of the selected processing unit being achieved using a sequence of quasi-random numbers.
